(19) United States
(12) Patent Application Publication
(10) Pub. No.: US 2008/0067314 A1
(43) Pub. Date: Mar. 20, 2008

(54) Flat panel display with detachable supporting member

(75) Inventors: Ming-Chuan Li, Miao-Li (TW); Te-Hsu Wang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/901,372

(22) Filed: Sep. 17, 2007

(30) Foreign Application Priority Data
Sep. 15, 2006 (TW) 95134270

(51) Int. Cl. F16M 11/12

(52) U.S. Cl. 248/398

(57) ABSTRACT

An exemplary flat panel display (200) includes a display module (22), a supporting arm (25), and a base (27). The supporting arm includes a slide plate (251). The base defines an accommodating space (275). The supporting arm is attached to the display module such that the display module is pivotable about the supporting arm. The slide plate is slidably received in the accommodating space such that the supporting arm is attached to the base, and the slide plate is slidably removable from the accommodating space such that the supporting arm is detached from the base. The supporting arm can be easily detached from the base. Thus, unduly large space inhabited by the supporting member can be effectively saved during the transportion of the flat panel display (200).

### FIELD OF THE INVENTION

The present invention relates to flat panel displays (FPDs), and particularly to an FPD with a detachable supporting member.

### GENERAL BACKGROUND

FIG. 6 is a rear, perspective view of a conventional FPD. The FPD 100 includes a display module 12, and a supporting member 13 supporting the display module 12. The display module 12 includes an axle 121. The supporting member 13 includes a supporting arm 15 and a base 17. The display module 12 is pivotally attached to the supporting arm 15 via the axle 121. The supporting arm 15 is integrally formed with the base 17.

The supporting member 13 is a somewhat bulky piece, and may occupy an unduly large amount of space. Once the FPD 100 has been fully manufactured and assembled at a factory, the space occupied by the supporting member 13 may contribute significantly to the overall space occupied by the FPD 100. When the FPD 100 needs to be packed for shipment, the size of the package is correspondingly large. This can make transportation of the FPD 100 inconvenient and costly.

It is desired to provide a new FPD which can overcome the above-described deficiencies.

### SUMMARY

In one aspect, a flat panel display includes a display module, a supporting arm, and a base. The supporting arm includes a slide plate and the base defines an accommodating space. The supporting arm is attached to the display module such that the display module is pivotable about the supporting arm. The slide plate is slidably received in the accommodating space such that the supporting arm is attached to the base, and the slide plate is slidably removable from the accommodating space such that the supporting arm is detached from the base.

In another aspect, a flat panel display includes a display module, a supporting arm, and a base. The display module is pivotably attached to the supporting arm and supported by the supporting arm and the base, and the supporting arm is detachably engaged with the base.

Other novel features and advantages will become more apparent from the following detailed description when taken in conjunction with the accompanying drawings.

### BRIEF DESCRIPTION OF THE DRAWINGS

FIG. 1 is a rear, perspective view of an FPD according to a preferred embodiment of the present invention, the FPD including a supporting member.

FIG. 2 is an exploded view of the FPD of FIG. 1.

FIG. 3 is a view of the supporting member of FIG. 1 shown in isolation.

FIG. 4 is a cross-sectional view taken along line IV-IV of FIG. 3.

FIG. 5 is a cross-sectional view taken along line V-V of FIG. 3.

FIG. 6 is a rear, perspective view of a conventional FPD.

### DETAILED DESCRIPTION OF PREFERRED EMBODIMENT

Reference will now be made to the drawings to describe a preferred embodiment of the present invention in detail.

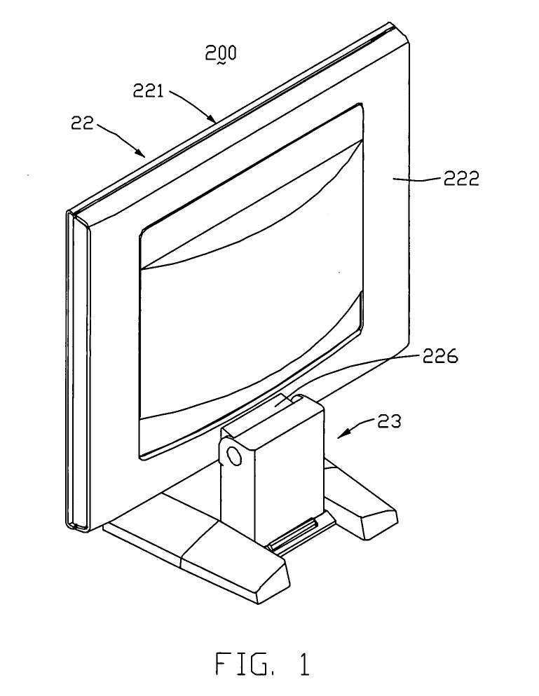

FIG. 1 is a rear, perspective view of an FPD according to a preferred embodiment of the present invention. The FPD 200 includes a display module 22, and a supporting member 23 supporting the display module 22. The display module 22 includes a front frame 221, a back bezel 222, and a display panel (not visible). The front frame 221 and the back bezel 222 cooperatively form an accommodating space for receiving the display panel. The display panel may be a liquid crystal panel, a plasma display panel, or the like. The back bezel 222 includes a hinge block 226 extending rearward from a main body thereof.

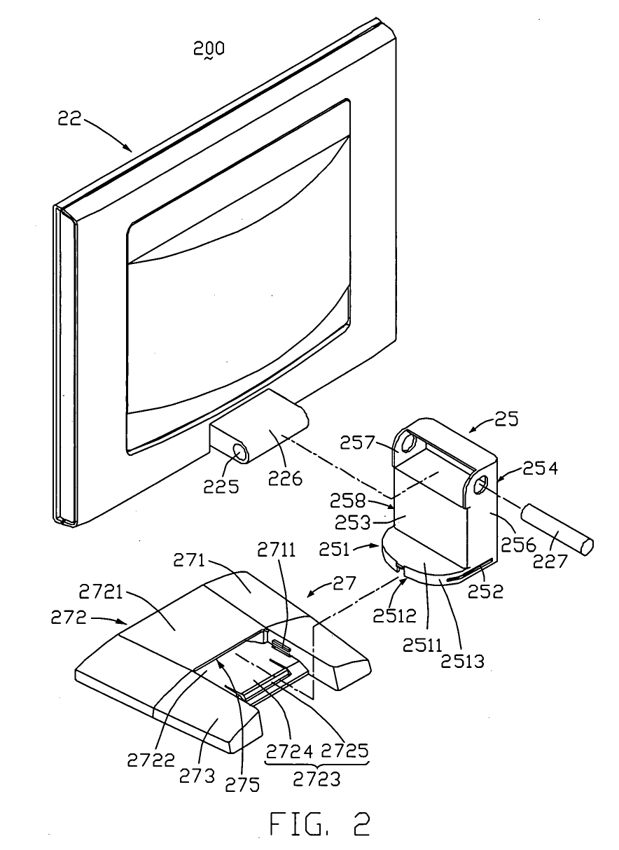

FIG. 2 is an exploded, perspective view of the FPD 200. The hinge block 226 includes a through hole 225 for accommodating an axle 227. The supporting member 23 includes a supporting arm 25 and a base 27. The supporting arm 25 includes a front wall 253, a back wall 254, a first side wall 256 adjacent to the front wall 253 and the back wall 254, and a second side wall 258 adjacent to the front wall 253 and the back wall 254. The front wall 253, the first side wall 256, the back wall 254, and the second side wall 258 cooperatively form four sides of a main body of the supporting arm 25. An upper portion of the first side wall 256 includes an axle collar 257, and an upper portion of the second side wall 258 includes another axle collar 257. A bottom end of the supporting arm 25 includes a slide plate 251. The axle collars 257 are configured to receive the axle 227. Thereby, the display module 22 is pivotally attached to the supporting arm 25, and is capable of rotating about the supporting arm 25.

The slide plate 251 perpendicularly extends from a bottom end of the front wall 253. The slide plate 251 includes an upper surface 2511, a bottom surface 2512, and a side surface 2513. The upper surface 2511, the side surface 2513, and the bottom surface 2512 cooperatively form substantially three sides of a main body of the slide plate 251. The side surface 2513 is arch-shaped, with two ends of the side surface 2513 being coplanar with the first side wall 256 and the second side wall 258 respectively. The side surface 2513 has two slots 252 defined thereat. The two slots 252 are at symmetrically opposite sides of the side surface 2513. Portions of the slots 252 are located directly beneath the first side wall 256 and the second side wall 258, respectively.

The base 27 includes a first part 271, a second part 272, and a third part 273. The first part 271 and the third part 273 are generally rectangular, and are located symmetrically relative to each other at opposite sides of the base 27. The second part 272 is located between the first part 271 and the third part 273. The second part 272 includes an upper cover 2721 and a lower cover 2722. The upper cover 2721, the lower cover 2722, the first part 271, and the third part 273 cooperatively define an accommodating space 275. The accommodating space 275 can accommodate the slide plate 251 of the supporting arm 25. The lower cover 2722 includes an elastic plate 2723 at a rear end thereof. The elastic plate 2723 includes an main body 2724 extending from a main body of the lower cover 2722, and a retaining ridge 2725 extending upwardly from a free edge of the main body 2724. An inner surface of the first part 271 opposite to the third part 273 has a guiding rib 2711 formed thereon. An inner surface of the third part 273 opposite to the first part 271 also has a guiding rib 2711 formed thereon. The two guiding ribs 2711 can be accommodated in the two slots 252, respectively.

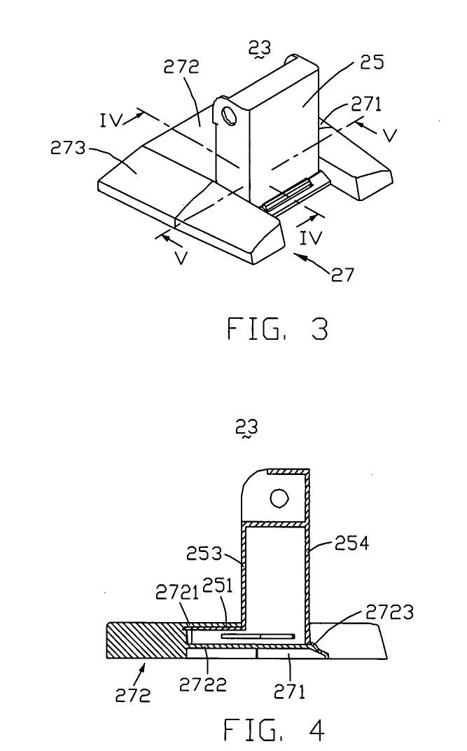

FIG. 3 is a perspective view of the supporting member 23. Assembly of the supporting member 23 is as follows. Firstly, the supporting arm 25 is pressed onto the retaining ridge 2725 of the elastic plate 2723. The retaining ridge 2725 is thereby depressed, and the slots 252 are aligned with the guiding ribs 2711 respectively. Then the supporting arm 25 is pushed forward into the accommodating space 275. When the front wall 253 reaches the upper cover 2721 of the second part 272, the retaining ridge 2725 of the elastic plate 2723 automatically snaps back up and abuts the back wall 254 of the supporting arm 25. Thereby, the assembly process is finished, with the supporting arm 25 being blocked from disengaging from the accommodating space 275 by the retaining ridge 2725. Thus, the process of assembly of the supporting member 23 is simple.

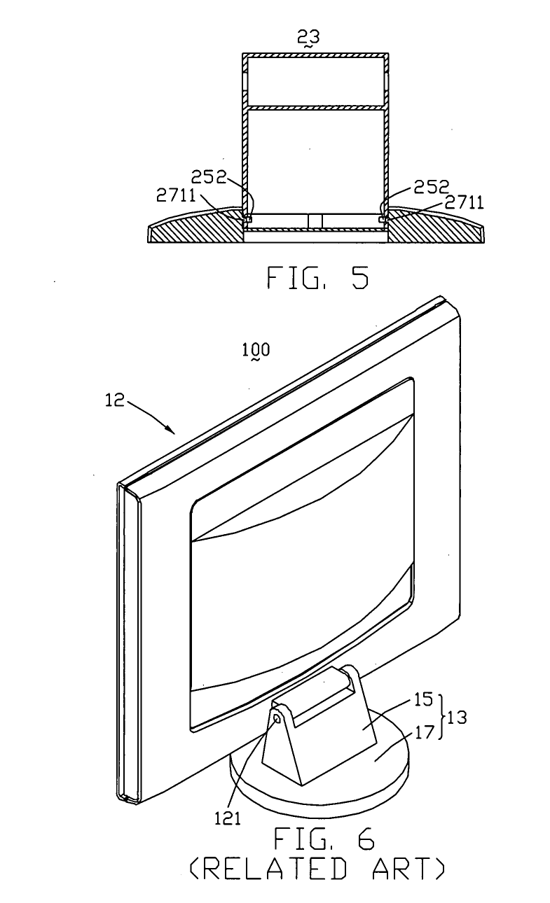

Referring also to FIG. 4 and FIG. 5, once the supporting member 23 is assembled, the accommodating space 275 accommodates the slide plate 251, the retaining ridge 2725 of the elastic plate 2723 blocks the back wall 254 of the supporting arm 25, and the slots 252 accommodate the guiding ribs 2711 respectively. Thus, the supporting arm 25 is securely attached to the base 27.

In disassembly, firstly, the retaining ridge 2725 of the elastic plate 2723 is pressed down. Then the supporting arm 25 is pulled to make the slide plate 251 slide out from the accommodating space 275. When the guiding ribs 2711 are completely disengaged from the slots 252, the supporting arm 25 is readily separated from the base 27. Thus, the process of disassembly of the supporting member 23 is simple too.

Unlike with conventional supporting members, the supporting member 23 has the supporting arm 25 that can be easily detached from the base 27 when needed. Then the flat base 27 can be conveniently stored alongside the display module 22 having the supporting arm 25. This assemblage occupies a relatively small space overall. Thus, storage and transportation of the FPD 200 can be efficient and inexpensive.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of present invention to the full extent indicated by the broad general meaning of the terms in which the appended claims are expressed.

What is claimed is:

1. A flat panel display, comprising:
a display module;
a supporting arm attached to the display module such that the display module is pivotable about the supporting arm, the supporting arm having a slide plate; and
a base defining an accommodating space;
wherein the slide plate is slidably received in the accommodating space such that the supporting arm is attached to the base, and the slide plate is slidably removable from the accommodating space such that the supporting arm is detached from the base.

2. The flat panel display as claimed in claim 1, wherein the supporting arm comprises a front wall.

3. The flat panel display as claimed in claim 2, wherein the slide plate perpendicularly extends from a bottom edge of the front wall.

4. The flat panel display as claimed in claim 1, wherein the slide plate comprises an upper surface, a side surface, and a bottom surface.

5. The flat panel display as claimed in claim 4, wherein two opposite sides of the side surface of the slide plate have two slots defined thereat, respectively.

6. The flat panel display as claimed in claim 5, wherein the supporting arm comprises a front wall, a first side wall adjacent to the front wall, and a second side wall adjacent to the front wall, the first and second side walls being at opposite sides of the supporting arm.

7. The flat panel display as claimed in claim 6, wherein the two opposite sides of the side surface are coplanar with the first side wall and the second side wall, respectively.

8. The flat panel display as claimed in claim 7, wherein the two slots are symmetrical relative to each other, and portions of the two slots are located directly beneath the first side wall and the second side wall respectively.

9. The flat panel display as claimed in claim 1, wherein the base comprises a first part, a second part, and a third part between the first part and the second part.

10. The flat panel display as claimed in claim 9, wherein the third part comprises an upper cover and a lower cover.

11. The flat panel display as claimed in claim 10, wherein the accommodating space is cooperatively defined by the upper cover, the lower cover, the first part, and the second part.

12. The flat panel display as claimed in claim 11, wherein the lower cover comprises an elastic partion at a rear thereof.

13. The flat panel display as claimed in claim 12, wherein the elastic partion comprises an main body extending from a main body of the the lower cover, and a retaining protrusion extending upwardly from a free edge of the main body.

14. The flat panel display as claimed in claim 9, wherein an inner surface of the first part at the accommodating space has a guiding rib formed thereon, and an inner surface of the second part at the accommodating space has a guiding rib formed thereon.

15. The flat panel display as claimed in claim 1, wherein the display module comprises a display panel.

16. The flat panel display as claimed in claim 15, wherein the display panel is a liquid crystal panel.

17. The flat panel display as claimed in claim 15, wherein the display panel is a plasma display panel.

18. A flat panel display, comprising:
a display module;
a supporting arm; and
a base;
wherein the display module is pivotably attached to the supporting arm and supported by the supporting arm and the base, and the supporting arm is detachably engaged with the base.

19. The flat panel display as claimed in claim 1, wherein supporting arm comprises a slide plate, the base defines an accommodating space, and the slide plate is snappingly engaged with the base in the accommodating space.

20. A flat display panel comprising:
a display module;
a supporting arm; and
a base; wherein the display module is pivotably attached to the supporting arm and supported by the supporting arm and the base, and the supporting arm is linearly slidably mounted on the base.
